(19) United States
(12) Patent Application Publication
(10) Pub. No.: US 2015/0219440 A1
(43) Pub. Date: Aug. 6, 2015

(54) MULTI-ANALYSIS ALGORITHM USING SIGNAL SHARING AND RELATED APPARATUS

(71) Applicant: SAMSUNG ELECTRONICS CO., LTD., Suwon-si (KR)

(72) Inventors: YOUNG-SEOK KIM, HWASEONG-SI (KR); JONG-SUN PEAK, HWASEONG-SI (KR)

(21) Appl. No.: 14/496,165

(22) Filed: Sep. 25, 2014

(30) Foreign Application Priority Data
Feb. 5, 2014 (KR) 10-2014-0013225

(51) Int. Cl. G01B 11/06

(52) U.S. Cl. CPC G01B 11/06; G01B 2210/56

(57) ABSTRACT

A multi-analysis method and apparatus use a plurality of analysis models to determine different traits of a sample from a signal produced from the sample. The analysis models include a model-THK and a model-CD. An optical signal from a pattern is produced. A thickness of the pattern is determined from the optical signal using the model-THK. A critical dimension (CD) of the pattern is determined from the optical signal using the model-CD. The thickness and the CD are output. The determinations of the thickness of the pattern and the CD of the pattern are made from the same optical signal, i.e., from a one time or single examination of the sample.

### CROSS-REFERENCE TO RELATED APPLICATION

This application claims priority under 35 U.S.C. §119 to Korean Patent Application No. 10-2014-0013225 filed on Feb. 5, 2014, the disclosure of which is hereby incorporated by reference in its entirety.

### BACKGROUND

1. Field

The inventive concept relates to non-destructive methods and apparatus for analyzing semiconductor devices. In particular, the inventive concept relates to a non-destructive method of and apparatus for measuring physical traits, such as a thickness and critical dimension (CD), of semiconductor devices.

2. Description of Related Art

Apparatus such as KLA SpectraShape 9000, KLA SpectraCD-XT, Nanometrics Atlas XP+, and Nanometrics Atlas II are used to measure characteristics of a semiconductor pattern, such as the thickness and critical dimension (CD) of the pattern, in a non-destructive manner. These measurement apparatus all tend to use several optical signals obtained from the semiconductor pattern, a model-THK, and a model-CD. For example, a semiconductor pattern is irradiated to produce a corresponding optical signal, and a thickness of the semiconductor pattern is calculated by comparing the optical signal with the model-THK. Subsequently, another optical signal is produced from the semiconductor pattern, and a CD of the semiconductor pattern is calculated by comparing the new optical signal with the model-CD. Thus, using these apparatus, N optical signals must be produced to provide measurements of several (N) different traits of the semiconductor pattern, i.e., the semiconductor pattern must be examined or tested several (N) times, and (N) measurements of signals must be made to determine several (N) different traits of the semiconductor pattern.

### SUMMARY

According to one aspect of the inventive concept, there is provided a multi-analysis method, which includes providing a plurality of analysis models, wherein the analysis models include a model-THK and a model-CD1, producing an optical signal from a feature, quantifying a thickness of the feature from the optical signal using the model-THK, quantifying a first critical dimension (CD) of the pattern from the optical signal using the model-CD1, and outputting data indicative of values of the thickness and the first CD.

According to another aspect of the inventive concept, there is provided a method of measuring a plurality of traits of a pattern of a semiconductor device, which includes irradiating a pattern of a semiconductor device, measuring an optical signal, produced as a result of the pattern having been irradiated using the light source, to obtain a value of the signal, quantifying one trait of the pattern by employing said value of the signal in a model of said one trait, quantifying another trait of the pattern, different from said one trait, by employing said value of the signal in a model of another trait, and transmitting data representative of values of the different traits. Accordingly, the same value is used to quantify different traits of the pattern of the semiconductor device.

According to another aspect of the inventive concept, there is provided a multi-analysis apparatus, which includes a measurement unit including a detector operable to detect an output from a sample in the measurement unit and produce a signal representative of the output, a controller operatively connected to the measurement unit to control an operation of the detector of the measurement unit, a model storage unit, comprising an electronic memory, operatively connected to the controller such that the controller can access data stored in electronic memory of the model storage unit, a signal storage unit, comprising an electronic memory, operatively connected to the controller such that the controller can access data stored in electronic memory of the signal storage unit, and an output unit operatively connected to the controller. In addition, the controller is configured to control the detector to detect an output from a sample in the measurement unit, and store the signal produced by the detector in the electronic memory of the signal storage unit, access the electronic memory of the model storage unit and quantify one trait of the sample by analyzing the signal using one model stored in the model storage unit, access the electronic memory of the model storage unit and quantify another trait of the sample by analyzing said signal again but this time using another model stored in the electronic memory of the model storage unit, and generate data representative of values of the different traits and transmit that data to the output unit. Accordingly, the same signal produced by the detector and stored in the electronic memory of the signal storage unit is used to quantify different traits of the sample.

According to another aspect of the inventive concept, there is provided a multi-analysis method, which includes providing a first analysis model and a second analysis model, examining a sample and producing a signal representative of the sample as a result of the examination of the sample, determining a first trait of the sample from a value of the signal using the first analysis model, determining a second trait of the sample from the value of the signal using the second analysis model, and outputting data representative of the first trait and the second trait.

According to another aspect of the inventive concept, there is provided a multi-analysis apparatus, which includes a measurement unit, a controller operatively connected to the measurement unit to control an operation of the measurement unit, a model storage unit operatively connected to the controller and in which is stored a first analysis model and a second analysis model, a signal storage unit operatively connected to the controller, and an output unit connected to the controller. In addition, the controller is configured to execute the operation of the measurement unit of examining a sample and producing a signal representative of the sample, determine a first trait of the sample from the signal using the first analysis model, determine a second trait of the sample from the signal using the second analysis model, and output data representative of the first trait and the second trait.

### BRIEF DESCRIPTION OF THE DRAWINGS

The foregoing and other features and advantages of the inventive concept will be more apparent from the detailed description of preferred embodiments of the inventive concept as follows, as illustrated in the accompanying drawings. In the drawings:

FIGS. 1, 2, 3 and 4 are flowcharts of methods of measuring a plurality of characteristics of a pattern of a semiconductor device in accordance with the inventive concept;

FIG. 5 is a schematic diagram of an embodiment of a measurement apparatus in accordance with the inventive concept;

FIG. 6 is a plan view of a pattern of a type whose traits can be measured in accordance with the inventive concept;

FIGS. 7 and 9 are cross-sectional views of the pattern; and

FIG. 8 is an enlarged sectional view of part of that pattern.

### DETAILED DESCRIPTION OF THE PREFERRED EMBODIMENTS

Various embodiments and examples of embodiments of the inventive concept will be described more fully hereinafter with reference to the accompanying drawings. Also, like numerals are used to designate like elements throughout the drawings.

Other terminology used herein for the purpose of describing particular examples or embodiments of the inventive concept is to be taken in context. For example, the terms “comprises” or “comprising” when used in this specification specifies the presence of stated features or processes but does not preclude the presence or additional features or processes. The term “pattern” may a times be used to refer to one feature (projection or space, for example) in a series of similar features formed by some patterning process or may refer collectively to the entire series of features formed by a patterning process.

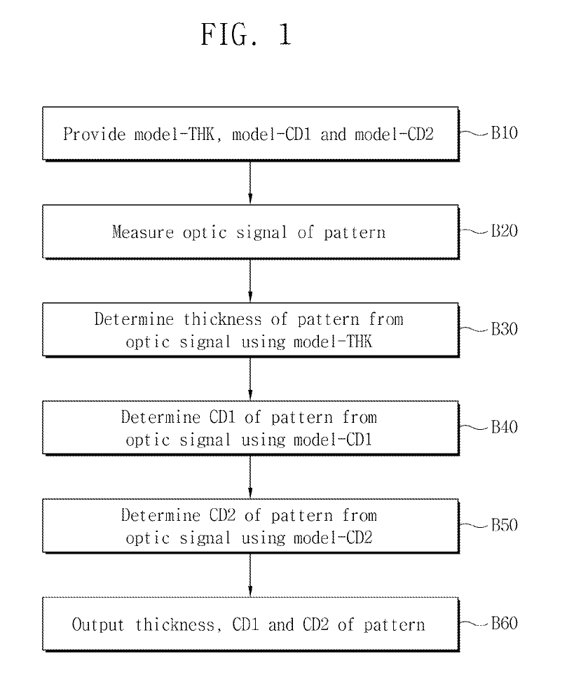

Methods of analyzing a pattern of a semiconductor device in accordance with the inventive concept will now be described in detail with reference to FIGS. 1-4.

In the embodiment of FIG. 1, an analysis method according to the inventive concept includes providing a plurality of analysis models including a model-THK, a model-CD1 and a model-CD2 (B10). Each of the models is a model of a respective trait (thickness, CD), as provided in the form of an algorithm or data set. A signal, representative of a pattern, is produced (B20). A thickness of the pattern may be quantified by analyzing the signal using the model-THK (B30). For example, a value of the signal is inserted into the thickness algorithm of model-THK. One critical dimension (CD1) of the pattern is quantified by analyzing the optical signal using the model-CD1 (B40). For example, the same value of the signal is inserted into the CD algorithm of model-CD1. Another critical dimension (CD2) of the pattern, i.e., a critical dimension of the pattern different from that of CD1, is quantified by analyzing the optical signal using the model-CD2 (B50). For example, the value of the signal is inserted into the CD algorithm of model-CD2. Data representative (of values) of the thickness, CD1, and CD2 of the pattern may be output (B60). In this embodiment, the values of the traits (thickness, CD1, and CD2) of the pattern are determined sequentially.

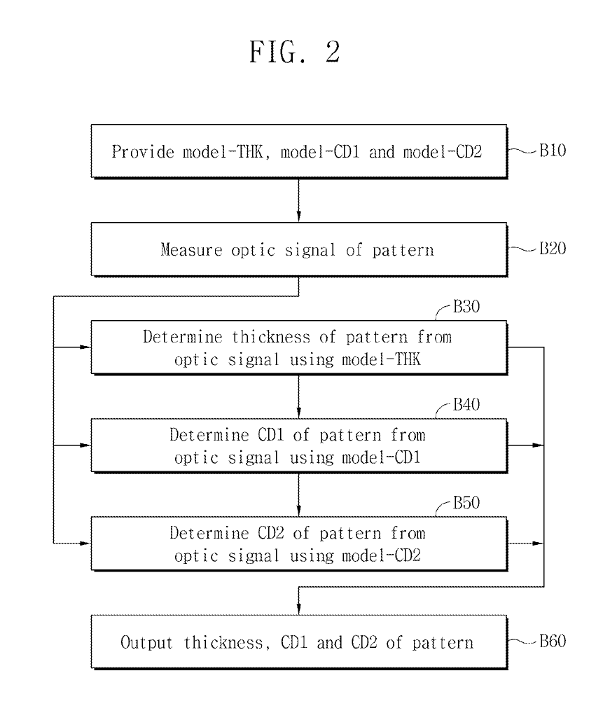

In the embodiment of FIG. 2, a plurality of analysis models including a model-THK, a model-CD1 and a model-CD2 are provided (B10). Each of the models is a model of a respective trait (thickness, CD), as provided in the form of an algorithm or data set. A signal, representative of (the topography of) a pattern, is produced (B20). A thickness of the pattern may be quantified by analyzing the optical signal using the model-THK (B30). One critical dimension (CD1) of the pattern is quantified by analyzing the same optical signal using the model-CD1 (B40). Another critical dimension (CD2) of the pattern, i.e., a critical dimension of the pattern different from that of CD1, is quantified by analyzing the optical signal using the model-CD2 (B50). Data representative of (values of) the thickness, the CD1, and the CD2 of the pattern may be output (B60). This embodiment is essentially the same as that of FIG. 1 except that the analyses of the optical signal to quantify the thickness, the CD1 and the CD2 of the pattern (B30, B40 and B50) are performed in parallel, i.e., simultaneously.

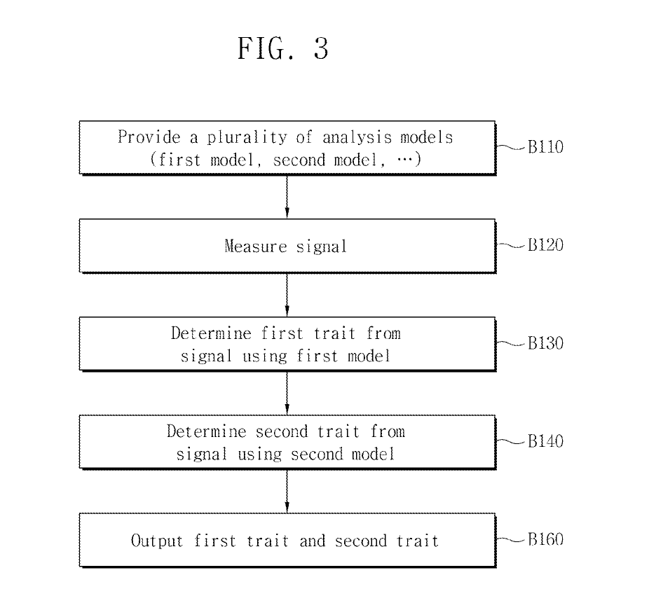

In the method shown in FIG. 3, a plurality of analysis models including a first model, a second model, etc. are provided (B110). Each of the models is a model of a respective trait as provided in the form of an algorithm or data set. A signal, representative of a sample having traits to be measured, is produced (B120). The traits may be different physical traits of the sample, such as various dimensions of a pattern. A first trait of the sample may be quantified by analyzing the signal using the first model (B130). A second trait of the sample may be quantified by analyzing the signal using the second model (B140). Values of the first trait and the second trait may be output (B160).

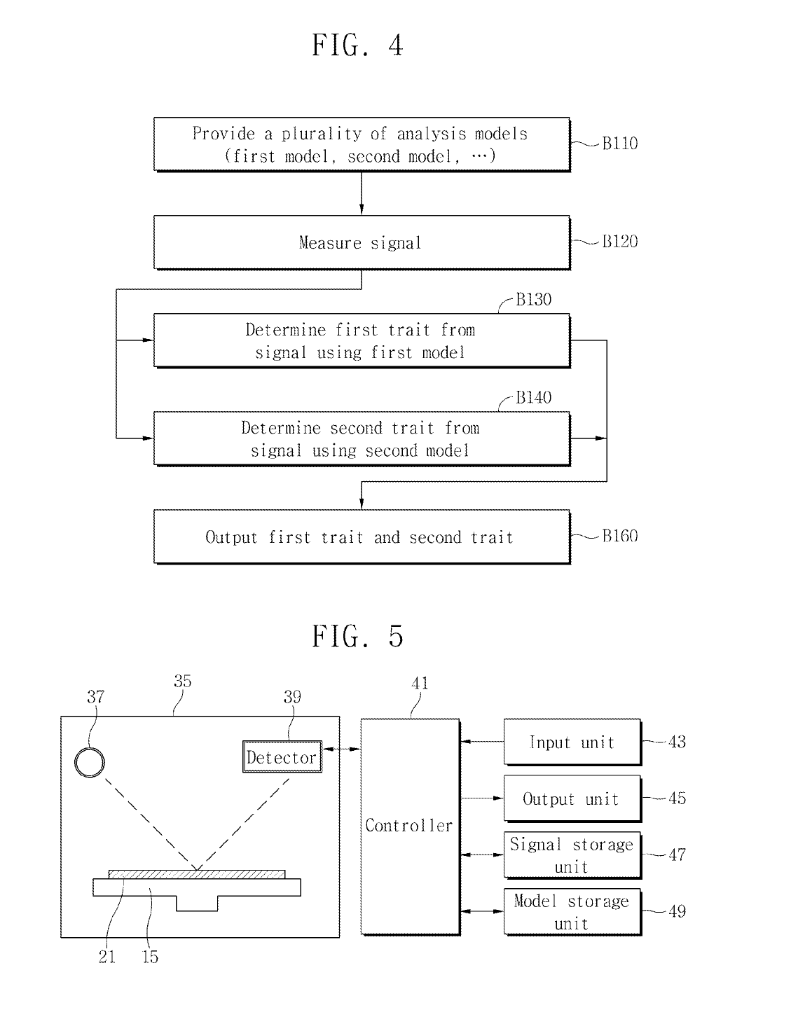

In the method shown in FIG. 4, a plurality of analysis models including a first model, a second model, etc. are provided (B110). Each of the models is a model of a respective trait (thickness, CD), as provided in the form of an algorithm or data set. A signal, representative of a sample whose traits are to be measured, is produced (B120). A first trait of the sample may be quantified by analyzing the signal using the first model (B130). A second trait of the sample may be quantified by analyzing the signal using the second model (B140). Values of the first trait and the second trait may be output (B160). In this embodiment, the analyses of the signal to quantify the first trait and the second trait (B130 and B140) are performed in parallel, i.e., simultaneously.

Measurement apparatus in accordance with the inventive concept will now be described in detail with reference to FIG. 5.

The measurement apparatus may be an optical measurement system or optical CD and shape measurement system. Examples of the optical CD and shape measurement system include a spectroscopic ellipsometer, a spectroscopic reflectometer, an ultra-violet reflectometer, and systems including a combination of these devices.

Referring to FIG. 5, the measurement apparatus includes a measurement unit 35, a controller 41, an input unit 43, an output unit 45, a signal storage unit 47, and a model storage unit 49. The measurement unit 35 may include a sample stage 15, a light source 37, and a detector 39.

The sample stage 15 is configured to support a sample whose characteristics are to be measured, such as those of a pattern on a semiconductor substrate 21. The light source 37 and the detector 39 may be disposed on opposite sides of the semiconductor substrate 21 from each other. The light source 37 serves to irradiate (illuminate) the semiconductor substrate 21. The detector 39 receives the radiation transmitted from the pattern (a feature or features) on the semiconductor substrate 21 (which transmitted light may be referred to as an “optical signal”) and converts the radiation into an electronic signal representative of the pattern irradiated by the light source. The controller 41 may be disposed adjacent to the measurement unit 35 and is operatively connected to the detector 39 to control the detector 39. Each of the input unit 43, the output unit 45, the signal storage unit 47, and the model storage unit 49 may be disposed adjacent to the controller 41 and in any case are operatively connected to the controller 41. Also, the signal storage unit 47, and the model storage unit 49 may each comprise an electronic memory.

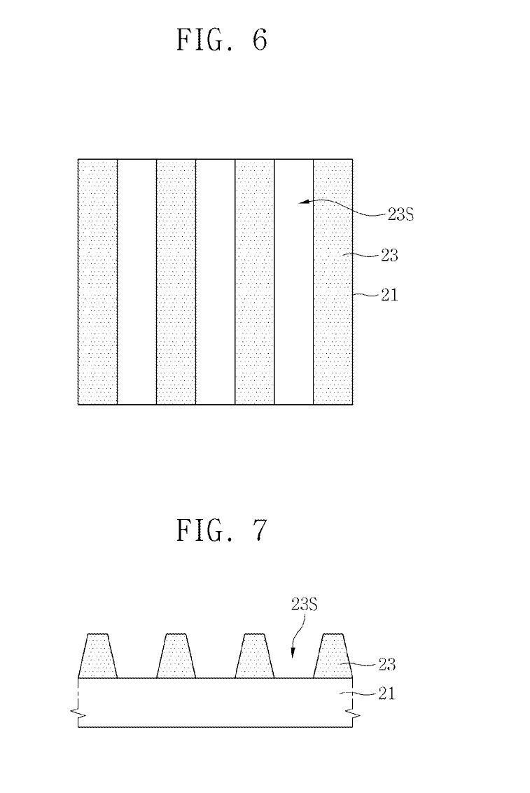

Referring to FIGS. 6 and 7, a plurality of patterns 23 and spaces 23S may be disposed/defined on semiconductor substrate 21. The semiconductor substrate 21 may be a bulk silicon wafer or silicon on insulator (SOI) wafer.

Furthermore, each of the patterns 23 protrudes from a surface of the semiconductor substrate 21. Each of the spaces 23S may be a trench (space that is elongated in a direction parallel to the surface of the semiconductor substrate 21, a contact hole, or the like.

Each of the spaces 23S may be defined by and between adjacent ones of the patterns 23. In this example, the patterns 23 and spaces 23S are each linear (as viewed in plan per FIG. 7) and together constitute a line and space pattern. Thus, the patterns 23 may be parallel to each other. Also, the patterns 23 may have similar shapes, the patterns 23 may be disposed at regular intervals from each other, and each of the spaces 23S may be grooves parallel to each other.

The patterns 23 may be of an electrically conductive material, an electrical insulating material, or a combination of electrically conductive and insulating materials. For example, the patterns 23 may include silicon oxide, silicon nitride, silicon oxynitride, polysilicon, or a combination thereof. Also, the patterns 23 may be transparent.

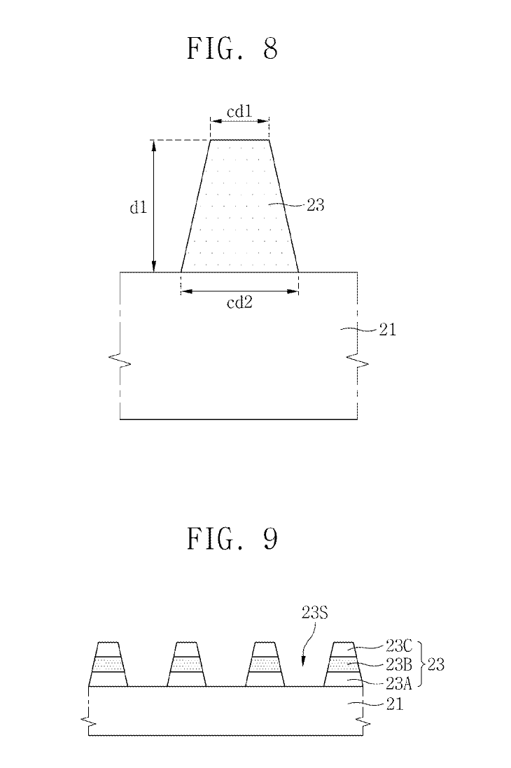

An upper portion of each pattern 23 may be narrower than its lower portion such that each of the patterns has inclined side surfaces 23, e.g., each of the patterns 23 may have a trapezoidal cross section, as shown in FIG. 8.

Referring to FIG. 9, each of the patterns 23 may include a plurality of thin films 23A, 23B and 23C. For example, each of the patterns 23 may include a first thin film 23A, a second thin film 23B disposed on the first thin film 23A, and a third thin film 23C disposed on the second thin film 23B.

However, methods and apparatus according to the inventive concept are applicable to patterns and spaces 23S having a layout, shapes as viewed in plan, cross-sectional shapes and compositions, etc., other than those shown in FIGS. 7-9 and described above.

Reference, however, will be made to the example shown in FIG. 8. In this example, each of the patterns 23 has a thickness d1, a first CD cd1, and a second CD cd2. The thickness d1 corresponds to the height of the pattern 23 from a bottom surface of the pattern 23 to a top surface of the pattern 23, the first CD cd1 is the width of the top surface of the pattern 23 (in a horizontal direction parallel to the upper surface of the substrate 21), and the second CD cd2 is the width of the bottom surface of the pattern 23. The first CD cd1 will be referred to hereinafter as the top-CD of the pattern(s) 23, and the second CD cd2 will be referred to hereinafter as the bottom-CD of the pattern(s) 23.

Referring again to FIGS. 1, 5, 7, and 8, a plurality of analysis models including a model-THK, a model-CD1 and a model-CD2 are provided (B10). In this example, the plurality of analysis models including the model-THK, the model-CD1 and the model-CD2 are input through the input unit 43 and stored in the model storage unit 49 through an operation of the controller 41. Each of the analysis models including the model-THK, the model-CD1 and the model-CD2 may be generated, verified and standardized by a calibration technique using a standard sample, a correlation technique using a destructive inspection apparatus, a simulation technique, or a combination of these techniques. Each of the analysis models including the model-THK, the model-CD1 and the model-CD2 may be optimized for its use in quantifying a respective characteristic (thickness of pattern, top CD of pattern, bottom CD of pattern) of a sample whose characteristics are to be measured, i.e., semiconductor substrate 21 having the patterns 23.

The semiconductor substrate 21 having the patterns 23 is loaded on the sample stage 15 in the measurement unit 35. An optical signal representative of the patterns 23 may be produced (B20). For example, the patterns 23 on the substrate 21 are irradiated by the light source 37, the resulting light transmitted from the patterns 23 is detected by the detector 39, the detector 39 converts the light (optical signal) into an electronic signal, and the electronic signal is stored in the signal storage unit 47 through an operation of the controller 41.

A thickness d1 of the patterns 23 is quantified from the optical signal using the model-THK (B30). For example, the controller 41 is configured to determine the thickness d1 by analyzing the signal stored in the signal storage unit 47 using the model-THK stored in the model storage unit 49. The thickness d1, again, corresponds to the height of each of the patterns 23.

A first CD cd1 of the patterns 23 is determined from the same optical signal using the model-CD1 (B40). For example, the controller 41 calculates the first CD cd1 by analyzing the signal stored in the signal storage unit 47 using the model-CD1 stored in the model storage unit 49. The first CD cd1 may correspond to the width of a top surface of each of the patterns 23 (smallest width of each of the patterns in this example).

A second CD cd2 of the patterns 23 is determined from the optical signal using the model-CD2 (B50). For example, the controller 41 calculates the second CD cd2 by analyzing the signal stored in the signal storage unit 47 using the model-CD2 stored in the model storage unit 49. The second CD cd2 may correspond to the width of the bottom of each of the patterns 23 (greatest width of each of the patterns in this example).

The thickness d1, the first CD cd1, and the second CD cd2 of the patterns 23 may be output (B60). For example, the controller 41 may serve to display or otherwise output values of the thickness d1, the first CD cd1, and the second CD cd2 via the output unit 45.

The analyzing of the optical signal to determine the thickness d1, the first CD cd1, and the second CD cd2 of the patterns 23 (B30, B40 and B50) may be sequentially performed.

Alternatively, the analyzing of the optical signal to determine the thickness d1, the first CD cd1, and the second CD cd2 of the patterns 23 (B30, B40 and B50) may be performed in parallel (simultaneously).

Also, only one of the first CD cd1 (B40) and the second CD cd2 (B50) may be determined, along with the thickness d1.

In yet another embodiment, the optical signal produced by irradiating the patterns 23 may be analyzed to determine the depth, a first CD, and a second CD of each of the spaces 23S. That is, the space or spaces 23S also constitute a pattern having a depth (corresponding to the thickness d1 in this example), a first CD (width of the uppermost part of the space 23S defined by and between the top surfaces of adjacent ones of the patterns 23) and a second CD (width of the lowermost part of the space 23S defined by and between the bottoms of adjacent ones of the patterns 23S).

According to an aspect of the inventive concept, the radiation transmitted from the patterns 23 is detected by the detector 39, converted by the detector into a signal, and stored as electronic data in the signal storage unit 47 through the controller 41. At least two traits from the group consisting, for example, of the thickness d1, the first CD cd1, and the second CD cd2 (B30, B40 and B50) of the patterns 23, are determined from the optical signal. Thus, relatively very little time is required to analyze the sample constituted by the semiconductor substrate 21 and patterns 23.

Referring again to FIGS. 3 and 5, a plurality of analysis models including a first model, a second model, etc. (B110) can be input through the input unit 43 and stored in the model storage unit 49 through an operation executed by the controller 41. Each analysis model is a model of a trait different from that represented by another of the analysis models. Thus, the models may be in the form of algorithms (functions) or data sets. Also, each of the analysis models may be optimized for use in determining a particular trait of a pattern, e.g., for use in determining a thickness of the pattern (height or thickness of one part of the pattern), or a width of a particular part of the pattern. Each of the analysis models may be verified and standardized by a calibration technique using a standard sample, a correlation technique with a destructive inspection apparatus, a simulation technique, or a combination of such techniques.

The semiconductor substrate 21 having the patterns 23 may be loaded on the sample stage 15 in the measurement unit 35. An optical signal may be produced from the patterns 23 (B120). For example, light may be transmitted from the patterns 23. The light is detected by the detector 39, converted into a signal and stored in the signal storage unit 47 through the controller 41.

A first trait of the patterns 23 may be determined from the signal using the first model (B130). For example, the controller 41 may calculate the first trait by analyzing the signal stored in the signal storage unit 47 using the first model stored in the model storage unit 49.

A second trait of the patterns 23 may be determined from the signal using the second model (B140). For example, the controller 41 may calculate the second trait by analyzing the signal stored in the signal storage unit 47 using the second model stored in the model storage unit 49. The second trait is a characteristic (e.g., dimension) of the patterns different from that of the first trait.

Data representative of the first trait and the second trait may be output (B160). For example, the controller 41 outputs data of the value of the first trait and the second trait through the output unit 45, where the data may be displayed.

The determining of the first trait and the second trait (B130 and B140) may be sequentially performed.

Alternatively, the determining of the first trait and the second trait (B130 and B140) may be performed in parallel (simultaneously).

According to an aspect of the inventive concept, the first trait and the second trait can be determined from the same signal without examining the sample a second time, i.e., before the controller controls the detector to detect another optical signal. Thus, it takes relatively little time to analyze the sample.

According to another aspect of the inventive concept, a multi-analysis algorithm and apparatus are provided in which the same value of a signal, obtained by measuring the signal once, is employed by at least two different analysis models to yield measurements of at least two different traits of a sample (pattern). Thus, it takes relatively little time to analyze the sample.

Finally, embodiments of the inventive concept and examples thereof have been described above in detail. The inventive concept may, however, be embodied in many different forms and should not be construed as being limited to the embodiments described above. Rather, these embodiments were described so that this disclosure is thorough and complete, and fully conveys the inventive concept to those skilled in the art. Thus, the true spirit and scope of the inventive concept is not limited by the embodiment and examples described above but by the following claims.

What is claimed is:

1. A multi-analysis method, comprising:
providing a plurality of analysis models, wherein the analysis models include a model-THK and a model-CD1;
producing an optical signal from a feature;
quantifying a thickness of the feature from the optical signal using the model-THK;
quantifying a first critical dimension (CD) of the pattern from the optical signal using the model-CD1; and
outputting data indicative of values of the thickness and the first CD.

2. The multi-analysis method of claim 1, wherein the quantifying of the thickness of the pattern and the quantifying of the first CD of the pattern are sequentially performed.

3. The multi-analysis method of claim 1, wherein the quantifying of the thickness of the pattern and the quantifying of the first CD of the pattern are performed in parallel.

4. The multi-analysis method of claim 1, wherein the analysis models further include a model-CD2 different from the model-CD1, and
further comprising quantifying another CD of the pattern from the optical signal using the model-CD2.

5. A method of measuring a plurality of traits of a pattern of a semiconductor device, the method comprising:
irradiating a pattern of a semiconductor device;
measuring an optical signal, produced as a result of the pattern having been irradiated using the light source, to obtain a value of the signal;
quantifying one trait of the pattern by employing said value of the signal in a model of said one trait;
quantifying another trait of the pattern, different from said one trait, by employing said value of the signal in a model of another trait,
whereby the same value is used to quantify different traits of the pattern of the semiconductor device; and
transmitting data representative of values of the different traits.

6. The method of claim 5, wherein the traits comprise a thickness of the pattern and a critical dimension (CD) of the pattern.

7. The method of claim 5, wherein the traits comprise two different critical dimensions (CDs) of the pattern.

8. The method of claim 7, wherein the traits comprise a critical dimension of an upper portion of the pattern and a critical dimension of a lower portion of the pattern.

9. The method of claim 5, wherein the traits are quantified sequentially using the optical signal.

10. The method of claim 5, wherein the traits are quantified simultaneously using the optical signal.

11. The method of claim 5, further comprising storing the optical signal in electronic form in a signal storage unit, comprising an electronic memory, under a command of a controller; and
storing said models, in electronic form, in a model storage unit comprising an electronic memory, and
wherein a detector is controlled by the controller to detect the optical signal, and
the analyzing of the optical signal using the models of data of said traits comprise accessing the signal storage unit and the model storage unit under the command of the controller after the optical signal has been stored in the electronic memory of the signal storage unit and before the detector is commanded by the controller to detect any other optical signal.

12. A multi-analysis method, comprising:
providing a first analysis model and a second analysis model;
examining a sample and producing a signal representative of the sample as a result of the examination of the sample;
determining a first trait of the sample from a value of the signal using the first analysis model;
determining a second trait of the sample from the value of the signal using the second analysis model; and
outputting data representative of the first trait and the second trait.
